(19) United States
(12) Patent Application Publication
(10) Pub. No.: US 2010/0077327 A1
(43) Pub. Date: Mar. 25, 2010

(54) GUIDANCE ACROSS COMPLEX TASKS

(75) Inventors: Jon Pulsipher, North Bend, WA (US); Ajitesh Kishore, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/235,032

(22) Filed: Sep. 22, 2008

(51) Int. Cl. G06F 9/46; G06F 3/048

(52) U.S. Cl. 715/764; 718/100

(57) ABSTRACT

Architecture that guides a user through a complex set of steps of a task that can span multiple applications and services, and/or multiple subprograms/services within a single application. A publication mechanism publishes categorized tasks and task steps to the end user client. Task publication allows end user/community modification or task creation for self use or for publishing to other users. A user interface (UI) associates a specific step with the larger task and helps the user to return back to the list of steps and otherwise navigate at the user discretion. A profile mechanism facilitates the storage of user choices over time and the development of a user profile from which future or similar task completion can be based. The architecture serves as a teaching tool that exposes the user to a variety of applications and services of which the user might now otherwise be aware.

### BACKGROUND

With the increasing number of application tools being developed each with more focused capability, users either lack the knowledge that the tools exist or do not know how to use the tools and information resources available via the user computer to assist in solving complex multi-step tasks, such as “find a new job”, “create a science fair project”, or “plan a trip together with another family”, for example.

Previous implementations of templates or wizards focus primarily only on a single application or only on a service domain. A word processor, for example, may provide resume templates and, a job search website offers advice and personal profiling tools. Another application has offered templates for to-do list items such as “do well in school”, but these lists are static and do not guide the user through steps to accomplish the items. Moreover, no application brings together all the parts of the problem under a single umbrella task in a way that makes sense to solving the problem at hand.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides the capability of automatically guiding a user through a complex set of steps of tasks that can span multiple applications and services, and/or multiple subprograms/services within a single application.

A profiling/scoring mechanism is provided that ensures the user is presented with an appropriate mix of the most used (or most-recently used) task categories as well as new categories that the user has not tried (or which are lower scoring). The resultant profiling data can then be used for marketing, merchandising, or other purposes. A task publishing mechanism can allow end user/community modification or task creation for customized use or for publishing to other users.

A publication mechanism publishes the categorized tasks (that include a number of individual steps which can span multiple applications or services to complete the final task) to the end user client. The publication can be over a network or locally.

A client application and/or service includes a user interface (UI) that presents the user with a list of candidate tasks from which one or more tasks can be selected, a task partitioned into steps, and then be guided through the completion of those steps. As the user is completing the steps, the UI associates a specific step with the larger task and helps the user to return back to the list of steps and otherwise navigate at the user discretion. A profile mechanism facilitates the storage of user choices over time and the development of a user profile from which future or similar task completion can be based.

The architecture, by way of its organizational nature and ability to select the appropriate tools for task completion also serves as a teaching tool that exposes the user directly to a variety of applications and services the user might not otherwise be aware of so the user can complete other tasks without assistance, if desired.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented task processing system in accordance with the disclosed architecture.

FIG. 2 illustrates an alternative implementation of a system for task processing.

FIG. 3 illustrates a system that facilitates user guidance across complex tasks.

FIG. 4 illustrates an exemplary user interface that can be accessed and presented using the navigation component.

FIG. 5 illustrates a method of processing a task using guide information.

FIG. 6 illustrates a method of creating and utilizing a customized task.

FIG. 7 illustrates a method of applying weighting to user and client actions.

FIG. 8 illustrates a method of providing new categories for discovery by a user.

FIG. 9 illustrates a method of pausing and re-enabling task execution using guide information.

FIG. 10 illustrates a block diagram of a computing system operable to provide task execution guidance in accordance with the disclosed architecture.

FIG. 11 illustrates a schematic block diagram of a computing environment for task guidance and execution across disparate resources.

### DETAILED DESCRIPTION

Conventional solutions to guide a user through the completion of a task such as wizards or templates focus on a single application or domain. However, there are many tasks that cross a variety of application or service domains such as finding a new job, for example. Continuing with this example, guidance to the user can begin with helping the user better understand self aptitude, interests, capabilities, etc., through information and tools such as aptitude tests or interest surveys on a career oriented website. Guidance can then progress to learning about the current job market and how the user skills fit that market. The user can then be guided through the selection of an appropriate resume template and the completion of that template in a word processing application. A possible next step can be to take advantage of the user's personal social network to review the resume and gather interesting leads. Finally, the user can be guided to the best locations to post the resume (e.g., based on community feedback and reviews) or to email the resume directly to the organizations with open positions of interest.

The disclosed architecture provides the capability of guiding the user through a complex set of steps that can span multiple applications and/or services and/or multiple subprograms/services within a single application. A profiling/scoring mechanism is provided to ensure the user is presented with an appropriate mix of the most-used and perhaps most-recently used (MRU) task categories as well as new categories that the user has not tried or which are lower scoring. The resultant profiling data can then be used for marketing, merchandising, or other purposes. A task publishing mechanism can allow end user/community modification or task creation for their own use or for publishing to other users.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

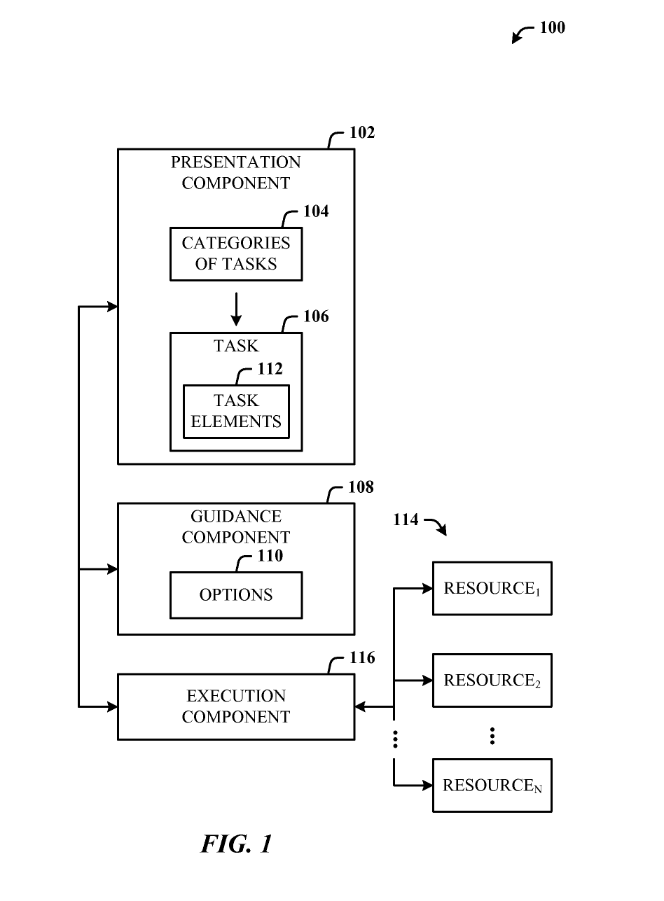

FIG. 1 illustrates a computer-implemented task processing system 100 in accordance with the disclosed architecture. The system 100 includes a presentation component 102 for presenting categories 104 of tasks for execution and selecting a task 106 from the categories of tasks 104. A guidance component 108 generates and presents selectable options 110 that guide execution of elements 112 of the task 106 across disparate resources 114 (denoted Resource₁,Resource₂, . . . ,Resource_{N}), and an execution component 116 for executing an element across the disparate resources 114 based on a selected option.

The resources 114 can be multiple disparate service domains that include databases and enterprise applications, for example. The resources 114 can also include disparate applications on single client machine, or clients and servers, for example. The categories of tasks 104 can be default categories such as “Things to do”, for example, where the category includes tasks such as “Create a resume” or “Plan a vacation”. Moreover, the tasks can include steps and substeps. The steps and substeps can be executed across multiple domains or a single domain, as well as a single application (of disparate subprograms) or multiple different applications.

The system 100 can be employed solely on a client machine or device to operate only with client applications, solely on a server for server-to-server operations, or operate cooperatively on a client and a server such that the client can access network-based applications and data, and the server can access client applications and data.

In one implementation, the system 100 can be employed in an enterprise such that the enterprise defines tasks for employees or enterprise users to perform that may not be performed that often (e.g., monthly, quarterly, annually, etc.). As will be described herein below, the system 100 can learn and provide more focused tasks for users over time. For example, if one user is routinely tasked with performing a step in a task, the guidance component 108 can suggest that this user again perform the step at a later time when the task is to be performed again. This also applies at the category level.

A first step to engaging the user is to provide an experience whereby the user is presented a list of candidate tasks for each category. The candidate tasks can be drawn from a larger source of tasks which may include categories of tasks such as vacation planning, job hunting, etc. Each task is composed of a number of steps and the individual steps may or may not be order dependent. If order dependent, the user is not allowed select a step before completing pre-requisite steps.

The initial list of candidate tasks can be randomly drawn from the available categories. In this initial interaction, the system has not had the opportunity to construct profile data for this new user. As the user selects a task, the category of that selection is tracked through a scoring algorithm as part of the user profile. This can mean that the user is more likely to see tasks from that category in the future.

Given that the system also engages the user and assists the user to discover applications and services previously unknown, one or more “slots” in the candidate task list are used for a randomly selected category of tasks other than tasks associated with the user profile. This “discovery” slot is one differentiator from conventional systems that may also be score based. The more the user interacts with a task (e.g., by completing steps within the task), the higher the score (weighting) will be for that category. Over time, the number of discovery slots available in the candidate task list becomes more tailored to the user based on past behavior.

Additional intelligence can also be applied. For example, if the user completes the “Find a New Job” task, the user will be more likely to want to see topics about excelling in a new job, rather than continually being prompted to find a new job.

The completion of the steps/substeps can involve local applications and/or online services. In some or all instances, there is a presentation made to the user as to the context, that is, why the user is seeing this application or service being used, and what does the application or service have to do with the task at hand.

Depending on the embodiment, the various components of the system may be fully server resident, fully locally resident on the computer or device, a hybrid of local and server based components, and/or may include a caching mechanism to allow use of the system when not connected to a network while retaining the scoring and profiling characteristics which are communicated to the server when a connection is available.

Over time, in addition to getting a candidate list of tasks that is more aligned with needs and interests, a user profile is being developed about the user through selections and interactions. This profile can then be used for commercial purposes such as merchandising and advertising efforts, for example.

An additional benefit for new users is that the user is exposed to the actual applications and services employed to solve the task, step, and/or substep. This prepares the user for additional exploration and engagement outside the guidance provided by the system.

The disclosed systems and components can be usable on a personal computer or other devices such as PDAs or mobile phones. The interaction with the system by way of keyboard, mouse, touch screen, speech or other input/output mechanisms can be tracked. Moreover, the task database could be open to community authoring and modification with the resulting tasks subject to user review and rating.

Additionally, task processing can be shared across systems. A task can include subtasks such that specific subtasks are performed on a mobile device, such as a phone, while other subtasks are performed on other devices (e.g., desktop computer). The tasks-sharing process can be manually directed in the sense that a subtask is specified to be processed on a device or automatically directed where the system decides what devices will process the subtasks. Furthermore, task sharing can be a combination of manually directed and automatically directed where the user specifies that the task or subtask be performed on a device, but the system then automatically directs one or more associated subtasks for processing on other devices. For example, the user can configure media sharing across a home network where some tasks are processed on a home PC or home server and other tasks are processed on various media players, game consoles, and/or mobile devices.

Generally, the architecture described herein in one or more embodiments is a rich, extensible application that takes the user through end-to-end scenarios, manages user conversations, and makes user events happen. Components can include a client that provides support for software and services for local and online access both for subscribers and non-subscribers. The application assists in end-to-end planning of events, activities, trips, etc., from initial conception through the complex details to sharing memories/photos, and planning follow-up events, if desired. The architecture includes an extensible and customizable planning engine where users are able to easily modify bundled solutions to fit more specific user needs and also create customized scenarios for user needs. These customized scenarios can then be shared privately with friends and or more globally to the entire user community. The architecture also provides conversation management by allowing the creation of temporary planning spaces as context for user dialog (e.g., conversations) where relevant ideas, opinions, and suggestions can be made, stored, and recalled. Personalized information gathering is provided for assisting users in finding information and filtering the information based on interests, preferences, and personalities, for example.

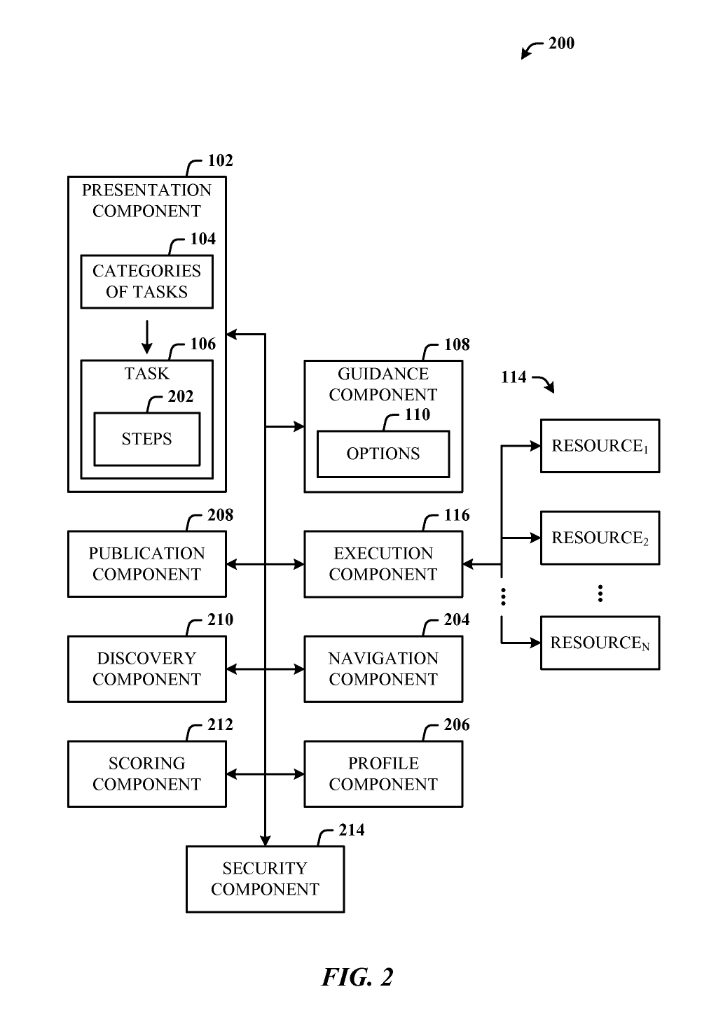

In support thereof, FIG. 2 illustrates an alternative implementation of a system 200 for task processing. The system 200 includes the presentation component 102 for presenting categories of tasks 104 from which a task 106 is selected for execution, the guidance component 108 for generating and presenting the options 110 that guide the completion of steps 202 of the task 106 across the resources 114 that include disparate applications or services. Additionally, the presentation component 102 can present a set of candidate tasks based on the user profile. A navigation component 204 maintains relationships between the tasks and steps, and facilitates navigation of the tasks and steps. A profile component 206 builds a user profile based in part on selections (e.g., category, task, task element, step) associated with task execution.

The system 200 can further comprise a publication component 208 for publishing the categories 104 and customized tasks or task steps for presentation by the presentation component 102. The publication component 208 can also publish a customized task or task element to other entities. In other words, users can create tasks, categories, steps, etc., other than the defaults. These can then be distributed to other user systems for use.

A discovery component 210 tailors the categories 104 to a user based on user interaction over time. The discovery component 210 can randomly select and include a new category in the categories for presentation and discovery by the user. The new category may not have been previously selected as part of task execution. The system 200 can further comprise a scoring component 212 for assigning weighting data to a category from which the task 106 was selected, the weighted category stored as part of the user profile and, the weighted category presented in the categories 104 based on selection of a new task and according to the user profile. The disparate resources 114 include at least one of applications or service domains, and can reside on a client computing system.

The system 200 can further employ a security component 214 for authorized and secure handling of user information (e.g., using selections, interaction, etc.). The security component 214 allows the user to opt-in and opt-out of tracking information as well as personal information that may have been obtained. The user can be provided with notice of the collection of personal information, for example, and the opportunity to provide or deny consent to do so. Consent can take several forms. Opt-in consent imposes on the user to take an affirmative action before the data is collected. Alternatively, opt-out consent imposes on the user to take an affirmative action to prevent the collection of data before that data is collected. This is similar to implied consent in that by doing nothing, the user allows the data collection after having been adequately informed.

The security component 214 also allows the user to access and update profile information. For example, the user can view the personal and/or tracking data that has been collected, and provide corrections. Where sensitive personal information such as professional, health, and/or financial information can be tracked and obtained, the security component 214 ensures that the data is housed using security measures appropriate for the sensitivity of the data. Moreover, vendor access to such information can be restricted using the security component 214 to control access only to authorized viewers and systems.

The security component 214 ensures the proper collection, storage, and access to the user information while allowing for the dynamic selection and presentation of the content (e.g., features, products, and/or services) that assist the user to obtain the benefits of a richer user experience and to access to more relevant information.

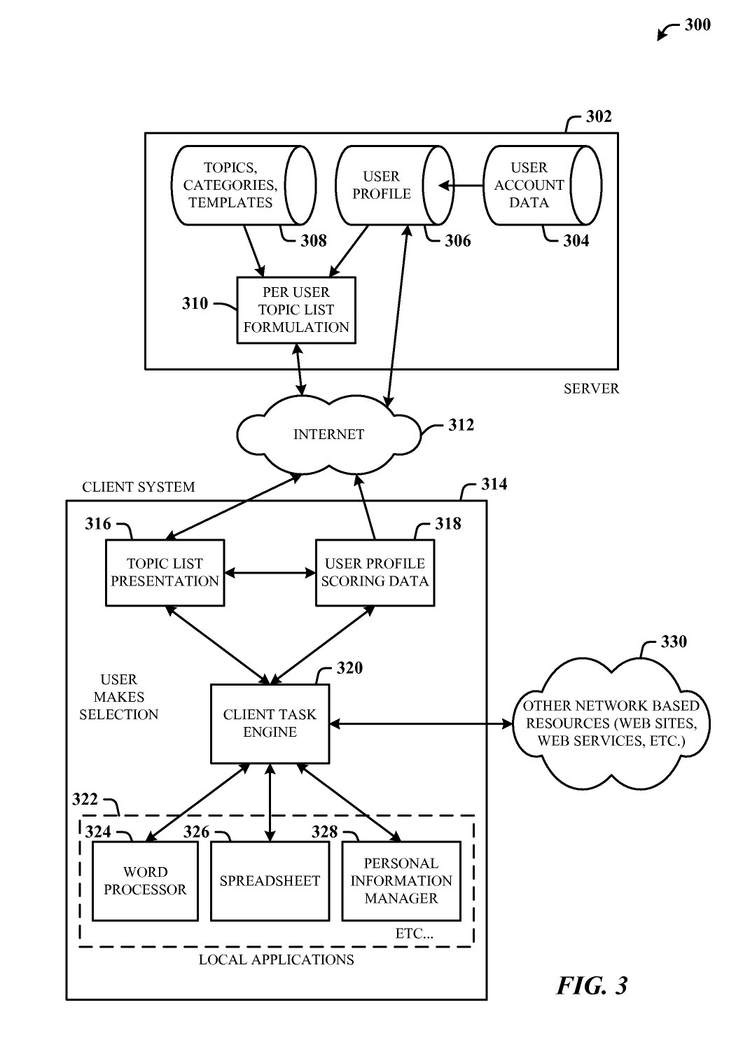

FIG. 3 illustrates a system 300 that facilitates user guidance across complex tasks. The system 300 includes a server 302 for storing user account data 304, user profile information 306, topics, categories, and templates 308, and other information as desired. These sources of information facilitate the formulation of a per user topic (category candidates) list 310. The server 302 can be disposed on the Internet 312 or other networks such as an enterprise network.

When a client launches on the client system 314, one or more client applications facilitate the disclosed task guidance architecture and pull the topic list 310 from the server 302 based on the profile information 306 to form a candidate list of categories for presentation 316 and from which to choose. If no profile information 306 exists, a randomization algorithm can operate to select categories to present to the user. The candidate list 310 can be on the order of 4-5 items, for example.

Selecting an item of the candidate list 310 increments user profile scoring data 318 for that user profile 306 stored in the server 302. A client task engine 320 receives the selection and processes the selection through local applications 322. The local applications 322 can include a word processor 324, a spreadsheet 326, personal information manager 328, and other applications such as for communications, presentation, and so on. There can be hard dependencies to processing tasks and subtasks, which are also adhered to by the task engine 320.

Additionally, user interactions through the task engine 320 can also affect the profile scoring data 318. For example, user selections based on curiosity about topics can result in a small number of appoints scored. However, task completion through the task engine 320 represents a more committed interaction than curiosity (explanation) selections and therefore can result in more points.

Task completion does not result in sending the finished product back to the server 302, but sending only scoring data 318, for example. The files are stored on the client system or wherever such files are desired to be stored. Moreover, the transactions are between the client and the resource (e.g., website) without intermediation by a third party.

It is within contemplation of the subject architecture that the task engine 320 can offload some or all processing to remote resources on other networks 330. Moreover, the task engine 320 can operate across subprograms within one (e.g., word processor 324) of the local applications 322, or a remote application.

The disclosed architecture serves as a teaching tool by guiding a less experienced user through task completion across available local and/or remote applications. For example, guide information can include not simply general information, but also chunks of script or other types of code for program development, compiling, etc.

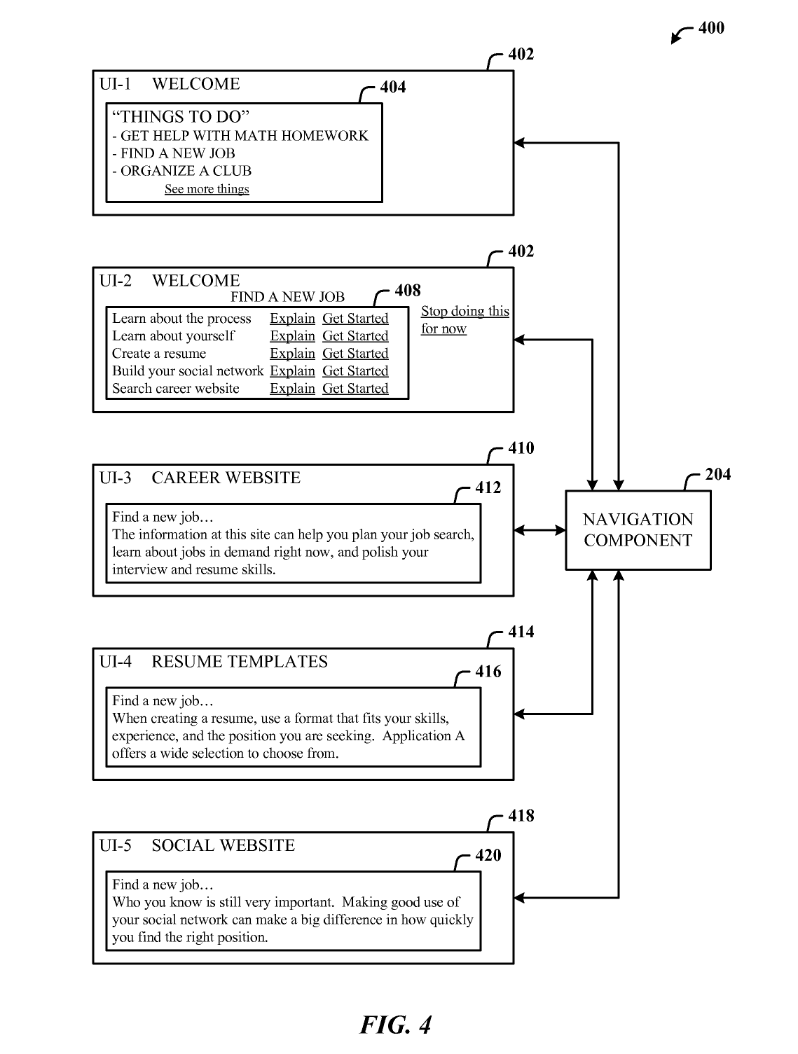

FIG. 4 illustrates an exemplary user interface (UI) 400 that can be accessed and presented using the navigation component 204. As previously indicated, the navigation component 204 provides the tracking and navigation at least between tasks, categories, and subtasks. The UI 400 can begin with an introductory page 402 (e.g., welcome page) and the guidance component generates first guide information 404 associated with a category of “Things to do”. The category includes multiple tasks such as “Get help with math homework”, “Find a new job”, etc. The first guide information 404 can also include an active more link (“See more things”) that when selected presents more similar tasks or different tasks under the category of “Things to do”, or entirely different categories. Selecting the more link can show the complete list broken down by category.

Here, the user selects the “Find a new job” task. In response, the guidance component generates and presents second guide information 408 in the introductory page 402 that shows subtasks (tasks and subtasks are also referred to as steps or task elements) that are related to finding a job. For example, the subtasks can include learning about the new job process, learning about the user's abilities, creating a resume, building a social network, and searching a career website. With each subtask entry, the second guide information 408 can include an active explanation link (“Explain”) that when selected explains what the subtask encompasses, and an active starting link (“Get Started”) for beginning the process denoted by the subtask. The second guide information 408 can also present a “hold” link (denoted “Stop doing this for now”) that pauses or even terminates processing of that task (“Find a new job”). However, the system facilitates coming back to that point in the processing to complete the task (or subtask) or restarting the task (or subtask). At a later time, the user can navigate to that point in the process using the navigation component 204 to find the point at which the “hold” occurred. The ability to hold or terminate the process can occur concurrently over many different tasks, subtasks, as well as categories.

Here, the user selects the “Explain” function associated with the subtask “Search career website”. The navigation component 204 then routes the user to an associated career website page 410. The guidance component then presents third guide information 412 that explains how the website can assist in finding a job, and other related functions.

The user can then choose to navigate back to the second guide information 408 and select a different subtask explanation such as “Create a resume”. Navigation is then to a website page 414 where fourth guide information 416 is presented that describes useful tips for creating a resume.

Similarly, the user can then choose to navigate back from the resume website page 414 to the second guide information 408 and select a different subtask explanation such as “Build a social network”. Navigation is then to a social website page 418 where fifth guide information 420 is presented that describes useful tips for building a social network.

As illustrated the guide information (404, 408, 412, 416 and 420) begins by presenting the category or task description (e.g., “Find a new job”) so that the user knows and can navigate back to other tasks, subtasks, or categories.

Although the category in the first guide information 404 lists three tasks, it is to be understood that more tasks can be listed. The same applies for lists of categories (not shown). Whenever the user makes a selection, whether for explanation, getting started, holding, a task, subtask, category, etc., that selection information can be used to build the user profile. According to one profile generation process, a first selection on presented content is weighted differently (e.g., less) than subsequent selections (e.g., more). Explaining can be weighted with fewer profile points than actually starting a task, for example. Additionally, the more activity the user performs in a category, task, subtask, etc., the more weighted that category is in the user profile. The weighting (or scoring) algorithm can be modeled on rules such as MRU, for example.

The tasks/subtasks can be performed in any order; however, if there is an optimum order, that information is included within the task/subtask and adhered to during task processing.

As previously indicated, an unallocated “slot” can be randomly filled. At least one item in the list is can be selected from a random category.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

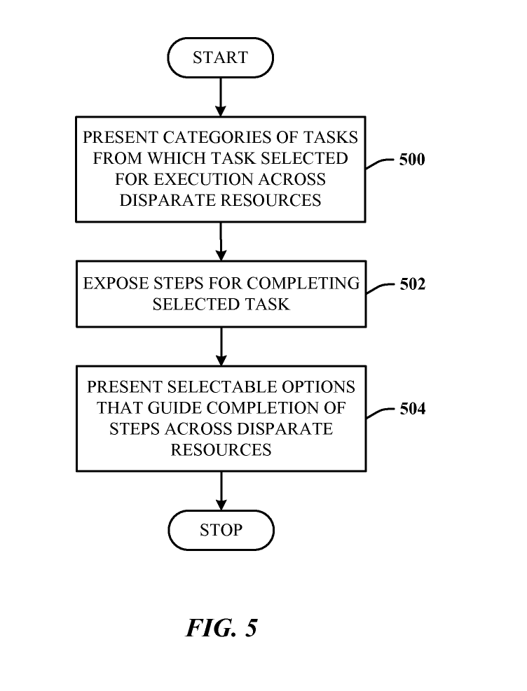

FIG. 5 illustrates a method of processing a task using guide information. At 500, categories of tasks are presented from which a task is selected for execution across disparate resources. At 502, steps for completing the selected task are exposed. At 504, selectable options that guide completion of the steps across the disparate resources are presented.

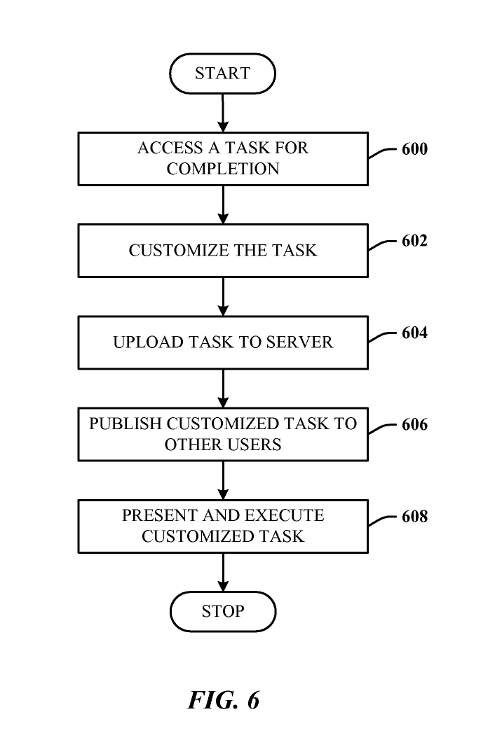

FIG. 6 illustrates a method of creating and utilizing a customized task. At 600, a task is accessed for completion. At 602, the user customizes the task. At 604, the customized task is uploaded to a server. At 606, the customized task is published to other users. At 608, the customized task is presented for execution by the user and other users.

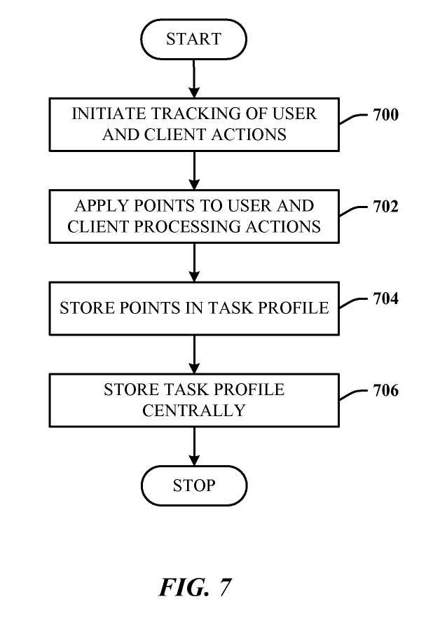

FIG. 7 illustrates a method of applying weighting to user and client actions. At 700, tracking of user and client actions is initiated. At 702, points are applied to the user and client processing actions. At 704, the points are stored in a task profile associated with the specific task. At 706, the task profile is stored centrally for future access.

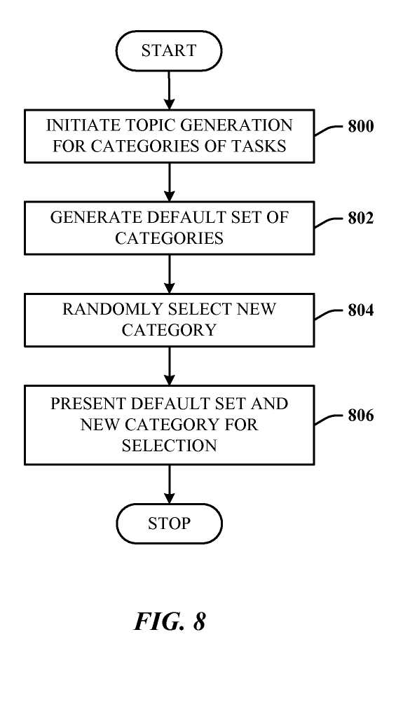

FIG. 8 illustrates a method of providing new categories for discovery by a user. At 800, topic generation for categories of tasks is initiated. At 802, a default set of categories is generated. At 804, a new category is randomly selected from all possible categories (custom created or otherwise). At 806, the default set and the new category are presented for selection.

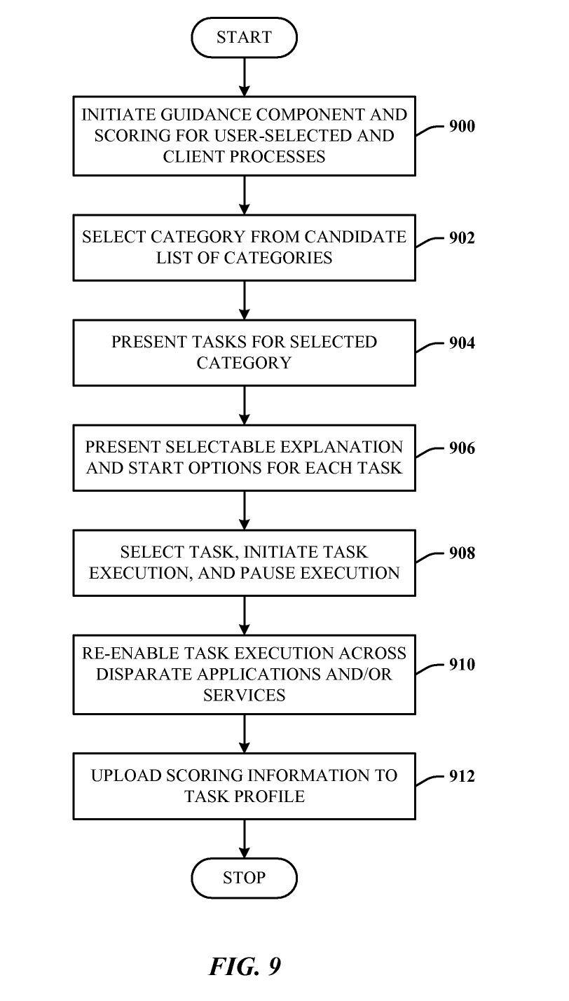

FIG. 9 illustrates a method of pausing and re-enabling task execution using guide information. At 900, the guidance component is initiated as well as scoring for user-selected and client processes. At 902, a category is selected from a candidate list of categories. At 904, tasks for the selected category are presented. At 906, selectable explanation and start options are presented for each task. At 908, a task is selected, task execution initiated, and the execution paused (or placed on hold). At 910, task execution is re-enabled across disparate applications and/or services. At 912, scoring information is uploaded to a task profile for future use.

As a general summary of some of the novel aspects described herein, tasks are defined and published on a network that is at least casually available to the end user client. Task properties include steps that are dependent upon other steps, workflow style and/or tasks which are not order dependent. Tasks can be organized into categories (e.g., education, career, travel, family, etc.), and can be modifiable by end users. Modified tasks can be publishable by the end users for other end users.

A task can include subtasks (or subitems), and the subtasks can further include subtasks. Tasks can be assigned pre-requisites such as the task will be processed using network connectivity or local applications/services. The backend (server) system includes a mechanism for publishing tasks to clients, and client profile storage.

Categories can be selected and presented based on most-recently-used (MRU) data. The list of candidate tasks exposed to the end user on the client initially includes items from random categories displayed in a limited number of “slots”. As the client user selects tasks (items) and on subtasks (subitems) of that task, the category of that task accumulates points. In one implementation, only the category accumulates points, and not the task. In an alternative implementation, both the category and the category tasks can accumulate points. These points are added to the profile. Moreover, tasks selected are stored to the user profile. After a threshold is exceeded, to prevent unpleasantly dynamic behavior of the category list early in the customer usage cycle, a number of the category list slots are populated with the highest scoring items.

In one implementation, there will be a number of the slots reserved to continue random behavior. This helps the user discover new things to do that may be of interest. There is a way for the user to see the entire list of categories and tasks. Additionally, there is a way for the user to see the list of tasks previously used by the user.

When the user selects a subtask in a task that opens another application, a website, or service in a browser or other client, there is a visual indication on the screen that associates the subtask to the task at hand and provides a way to stop and start this step, and return to the list of subtasks.

The profile information affects the makeup of the list the server sends to the client and can be used for other merchandising or profiling of the user (with appropriate consent). This means the user self-profiles through usage.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

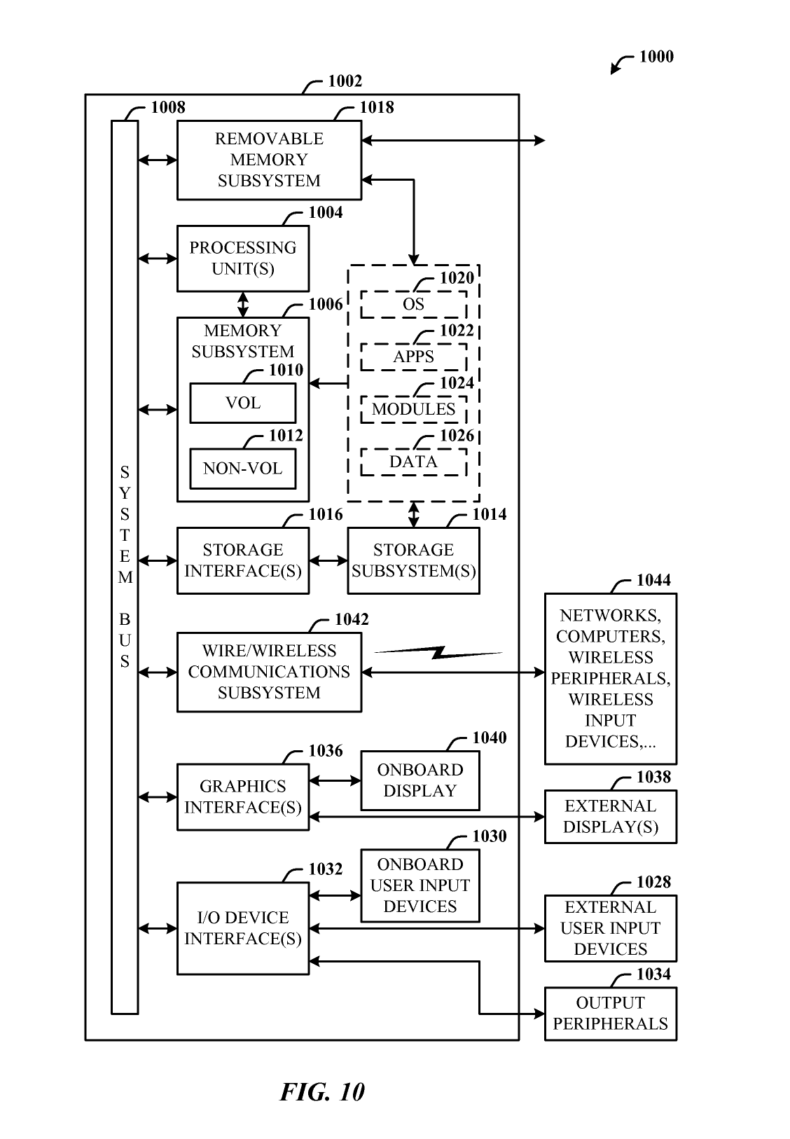

Referring now to FIG. 10, there is illustrated a block diagram of a computing system 1000 operable to provide task execution guidance in accordance with the disclosed architecture. In order to provide additional context for various aspects thereof, FIG. 10 and the following discussion are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the memory subsystem 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes storage subsystem(s) 1014 and storage interface(s) 1016 for interfacing the storage subsystem(s) 1014 to the system bus 1008 and other desired computer components. The storage subsystem(s) 1014 can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a removable memory subsystem 1018 (e.g., flash drive form factor technology), and/or the storage subsystem(s) 1014, including an operating system 1020, one or more application programs 1022, other program modules 1024, and program data 1026. Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The applications 1022, modules 1024, and/or data 1026 can include the presentation component 102, guidance component 108, execution component 116, navigation component 204, profile component 206, discovery component 208, scoring component 212, security component 214, client system 314 and entities thereof, UI 400, and one or more methods of FIGS. 5-9.

The storage subsystem(s) 1014 and memory subsystems (1006 and 1018) serve as computer readable media for volatile and non-volatile storage of data, data structures, computer-executable instructions, and so forth. Computer readable media can be any available media that can be accessed by the computer 1002 and includes volatile and non-volatile media, removable and non-removable media. For the computer 1002, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP) using logical connections via a wire/wireless communications subsystem 1042 to one or more networks and/or other computers. The other computers can include workstations, servers, routers, personal computers, microprocessor-based entertainment appliance, a peer device or other common network node, and typically include many or all of the elements described relative to the computer 1002. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wire/wireless communication subsystem 1042 (e.g., a network interface adapter, onboard transceiver subsystem, etc.) to communicate with wire/wireless networks, wire/wireless printers, wire/wireless input devices 1044, and so on. The computer 1002 can include a modem or has other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

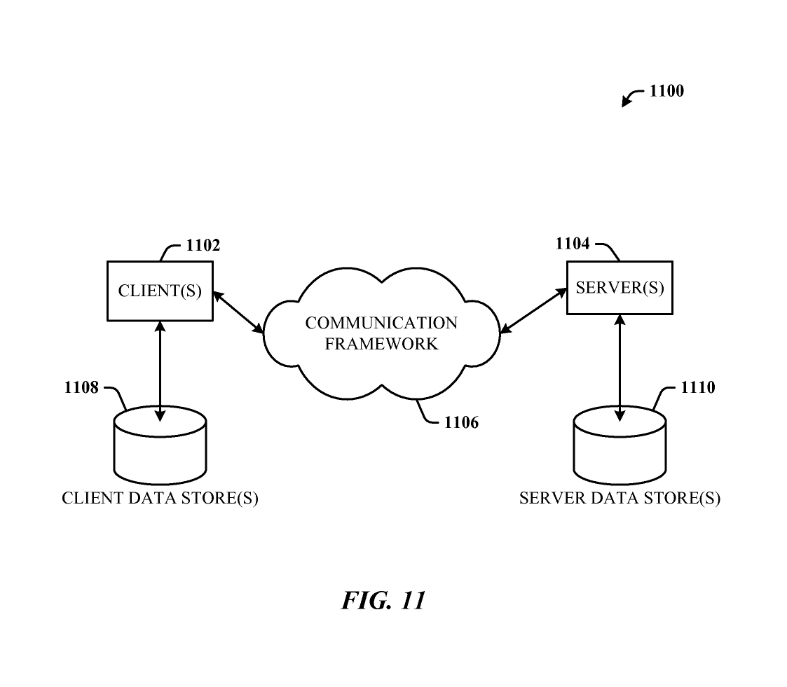

Referring now to FIG. 11, there is illustrated a schematic block diagram of a computing environment 1100 for task guidance and execution across disparate resources. The environment 1100 includes one or more client(s) 1102. The client(s) 1102 can be hardware and/or software (e.g., threads, processes, computing devices). The client(s) 1102 can house cookie(s) and/or associated contextual information, for example.

The environment 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The environment 1100 includes a communication framework 1106 (e.g., a global communication network such as the Internet) that can be employed to facilitate communications between the client(s) 1102 and the server(s) 1104.

The client(s) 1102 can include the client system 314, and the server(s) 1104 can include the server 302 and one or more methods of FIGS. 5-9.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented task processing system, comprising:
a presentation component for presenting categories of tasks for execution and selecting a task from the categories of tasks;
a guidance component for generating and presenting selectable options that guide execution of elements of the task across disparate resources; and
an execution component for executing an element across the disparate resources based on a selected option.

2. The system of claim 1, wherein the disparate resources include at least one of applications or service domains.

3. The system of claim 1, wherein the disparate resources reside on a client computing system.

4. The system of claim 1, further comprising a profile component for building a user profile based in part on a category selected.

5. The system of claim 4, wherein the presentation component presents a set of candidate tasks based on the user profile.

6. The system of claim 1, further comprising a navigation component for maintaining relationships of the tasks and task elements and facilitating navigation of the tasks and task elements.

7. The system of claim 1, further comprising a publication component for publishing the categories for presentation by the presentation component.

8. The system of claim 1, further comprising a publication component for publishing a customized task or task element to other entities.

9. The system of claim 1, further comprising a discovery component for randomly selecting and including a new category in the categories for presentation, the new category not previously selected as part of task execution.

10. A computer-implemented task processing system, comprising:
a presentation component for presenting categories of tasks from which a task is selected for execution;
a guidance component for generating and presenting options that guide completion of steps of the task across disparate applications or services;
a navigation component for maintaining relationships between the tasks and steps and facilitating navigation of the tasks and steps; and
a profile component for building a user profile based in part on selections associated with task execution.

11. The system of claim 10, further comprising a scoring component for assigning weighting data to a category from which the task was selected, the weighted category stored as part of the user profile and, the weighted category presented in the categories based on selection of a new task and according to the user profile.

12. The system of claim 10, further comprising a publication component for publishing the categories and customized tasks or task steps for presentation by the presentation component.

13. The system of claim 10, further comprising a discovery component for tailoring the categories to a user based on user interaction over time.

14. A computer-implemented method of processing a task, comprising:
presenting categories of tasks from which a task is selected for execution across disparate resources;
exposing steps for completing the selected task; and
presenting selectable options that guide completion of the steps across the disparate resources.

15. The method of claim 14, further comprising:
customizing a task; and
publishing the customized task to other entities.

16. The method of claim 14, further comprising:
applying points to the task based on user interaction and client processing; and
storing the points as a score of a task profile for a user.

17. The method of claim 16, further comprising selecting the categories based on the task profile of the user.

18. The method of claim 16, further comprising processing the profile to extract user information and provide targeted content to a user based on the user information.

19. The method of claim 14, further comprising:
randomly selecting a new category; and
presenting the new category in the categories.

20. The method of claim 14, further comprising delaying execution of the task for a later time.
